(19) United States
(12) Patent Application Publication
(10) Pub. No.: US 2018/0114509 A1
(43) Pub. Date: Apr. 26, 2018

(54) Close Captioning Size Control

(71) Applicant: Lenovo (Singapore) Pte. Ltd., Singapore (SG)

(72) Inventors: John C. Mese, Cary, NC (US); Nathan J. Peterson, Oxford, NC (US); Russell S. VanBlon, Raleigh, NC (US); Arnold S. Weksler, Raleigh, NC (US)

(21) Appl. No.: 15/298,989

(22) Filed: Oct. 20, 2016

(51) Int. Cl. G09G 5/26; H04N 21/431; H04N 21/488

(52) U.S. Cl. CPC G09G 5/26; H04N 21/4884; H04N 21/4312

(57) ABSTRACT

An approach is disclosed that detects a distance from a user to the display screen using a sensor. A font size is then determined based on the detected distance. A closed captioned text is then displayed on the display device, with the closed captioned text being displayed in the determined font size.

### BACKGROUND

Closed Captioning (CC) is a process of displaying text on a visual display, such as a television, to provide a textual transcription of an audio portion of a program as it occurs. The closed captioning text can be provided verbatim or in edited form, sometimes also including descriptions of sounds and other non-speech elements of the program. Closed Captioning is typically a fixed size that appears on a display screen. The size of the font used for Closed Captioning may be too big or too small to see based on the user's distance from the television display. There might be a setting to adjust the size of the close captioning text, but once set, traditional approaches require the user to reset it, often by traversing various menu controls. Another problem is that other viewers might like a different setting than what was selected. For example, a person with poorer eyesight might prefer a larger font size used in the closed captioning, while someone with better eyesight might prefer a smaller font size so that the closed captioning does not occupy too much space on the television display.

### SUMMARY

An approach is disclosed that detects a distance from a user to the display screen using a sensor. A font size is then determined based on the detected distance. A closed captioned text is then displayed on the display device, with the closed captioned text being displayed in the determined font size.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting a system that adjusts the font size used in presenting closed captioning text based upon a distance that the user, or viewer, is from the display;

FIG. 4 is a flowchart showing steps performed to adjust the font size when presenting closed captioning to one or more users; and

FIG. 5 is a flowchart showing steps performed to detect distance from the display device to one or more users proximate to the television display.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

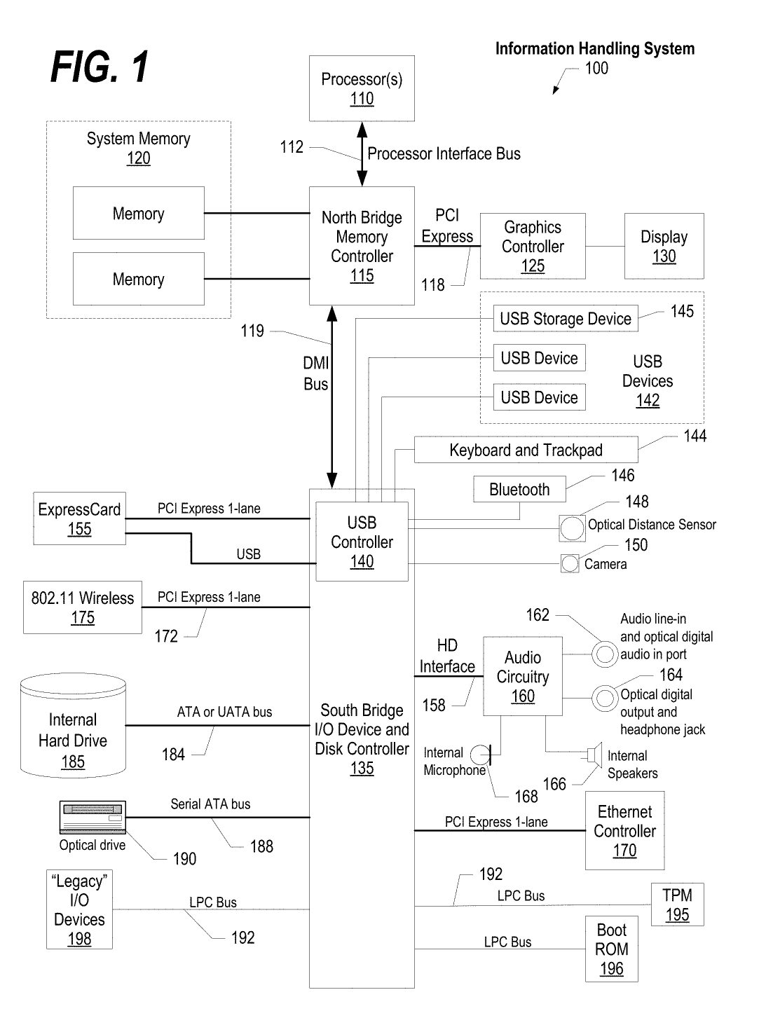

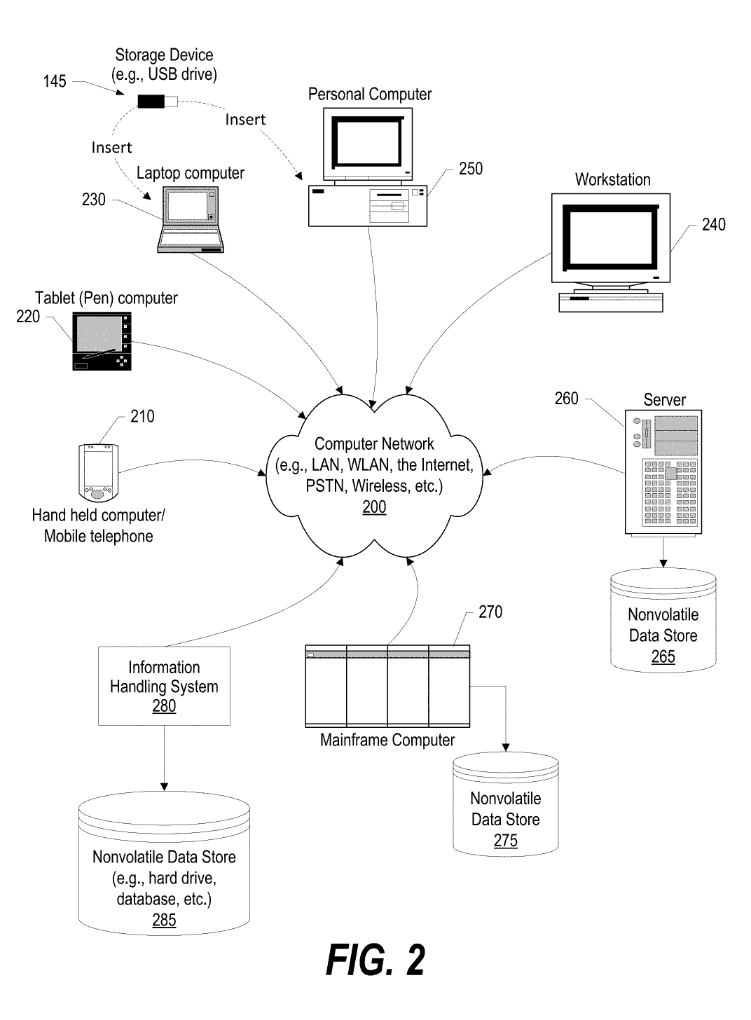

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include digital camera 150, optical distance sensor 148, keyboard and trackpad 144, and Bluetooth device 146, which provides for wireless personal area networks (PANs). Optical distance sensor 148 can detect the distance from a device to various objects, such as users of the system, while digital camera 150 can be used to capture images of objects, such as users of the system, to enable recognition software, such as facial recognition software, to identify the users of the system. USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

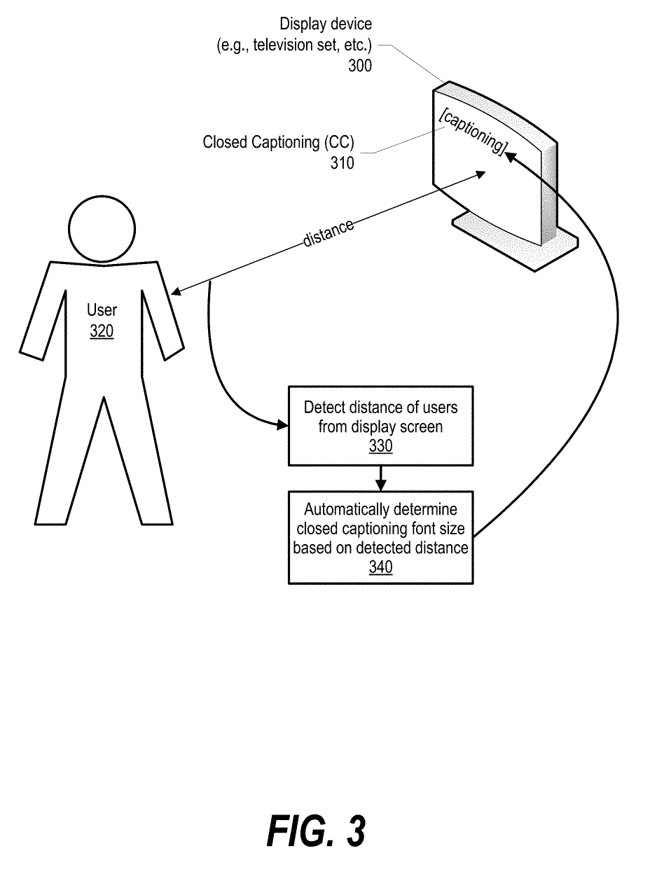

FIG. 3 is a diagram depicting a system that adjusts the font size used in presenting closed captioning text based upon a distance that the user, or viewer, is from the display. Display device 300 includes a display screen on which images, such as a television program appear. When enabled, Closed Captioning (CC) is displayed on the screen with the text appearing in the closed captioning being a textual transcription of the audio portion of the screen, in either verbatim or edited format. User 320 is depicted as a user of the display device and, as such is watching the program that appears on the display screen. The approach provided herein performs additional processing to display the closed captioning text in a font size that is suitable to user 320. At step 330, the system detects the distance of user 320 from display device 300. An optical distance sensor can be used to detect this distance. At step 340, the process automatically determines the font size to use when displaying the Closed Captioning text based on the distance of the user from the display device.

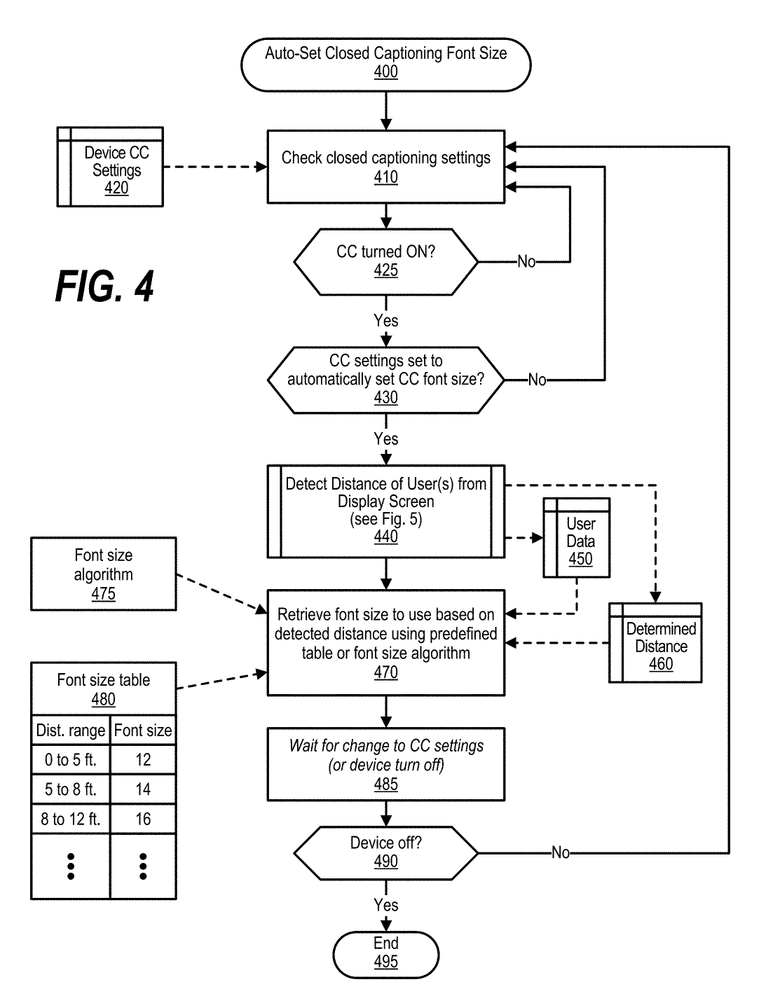

FIG. 4 is a flowchart showing steps performed to adjust the font size when presenting closed captioning to one or more users. FIG. 4 processing commences at 400 and shows the steps taken by a process that automatically sets a Closed Captioning font size based on a distance that a user is from a display device. At step 410, the process repeatedly checks the closed captioning settings associated with the display device by reading the closed captioning settings from memory area 420. The process determines whether Closed Captioning has been turned ON for the display device (decision 425). If Closed Captioning has not yet been turned ON for the display device, then decision 425 branches to the ‘no’ branch which loops back to step 410 to repeatedly check the Closed Captioning settings. This looping continues until a check of the settings indicates that Closed Captioning has been turned ON, at which point decision 425 branches to the ‘yes’ branch exiting the loop. The process next determines whether Closed Captioning settings have been set to automatically set the Closed Captioning font size (decision 430). If Closed Captioning settings have not been set to automatically set the Closed Captioning font size, then decision 430 branches to the ‘no’ branches to the ‘no’ branch which loops back to step 410 to repeatedly check the Closed Captioning settings. This looping continues until both Closed Captioning has been turned ON and the settings have been set to automatically set the Closed Captioning font size, at which point decision 430 branches to the ‘yes’ branch exiting the loop.

At predefined process 440, the process performs the Detect Distance routine (see Figure and corresponding text for processing details). This routine determines the distance of the user from the display device and stores the determined distance in memory area 460. In addition, In one embodiment the routine also identifies users that are watching the display device and retrieves metadata regarding the users, such as whether one of the users has one or more impairments that necessitate use of closed captioning with a particular font size. The data pertaining to identified users is stored in memory area 450.

At step 470, the process retrieves the font size to use for the Closed Captioning system based on the detected distance. Step 470 can use one or more predefined tables, such as table 470, that have distance ranges and corresponding font sizes to use for such distances. Step 470 can also use font size algorithm 475 which is an algorithm that, given the determined distance as an input, calculates a font size to use fot the distance. In addition, step 470 can also use user identity data 450 stored in memory area 450 to select different font size tables or font size algorithms based on the identified user. For example, when one user (user “A”) is eight to twelve feed from the display device, the table that is retrieved for this user (table “A”) might indicate a font size of 16, whereas when a different user (user “B”) is the same distance from the display device, the table that is retrieved for this user (table “B”) might indicate a font size of 20. The font size that is retrieved is used to display the text in the Closed Captioning system on the display device.

At step 485, the process waits for a change to occur with the Closed Captioning settings of the system, or alternatively for the device to be turned off. The process determines whether the device has been turned off (decision 490). If the device has not been turned off, then decision 490 branches to the ‘no’ branch which loops back to step 410 to retrieve the changed Closed Captioning system settings and proceed as described above. On the other hand, if the device has been turned off, then decision 490 branches to the ‘yes’ branch whereupon processing ends at 495.

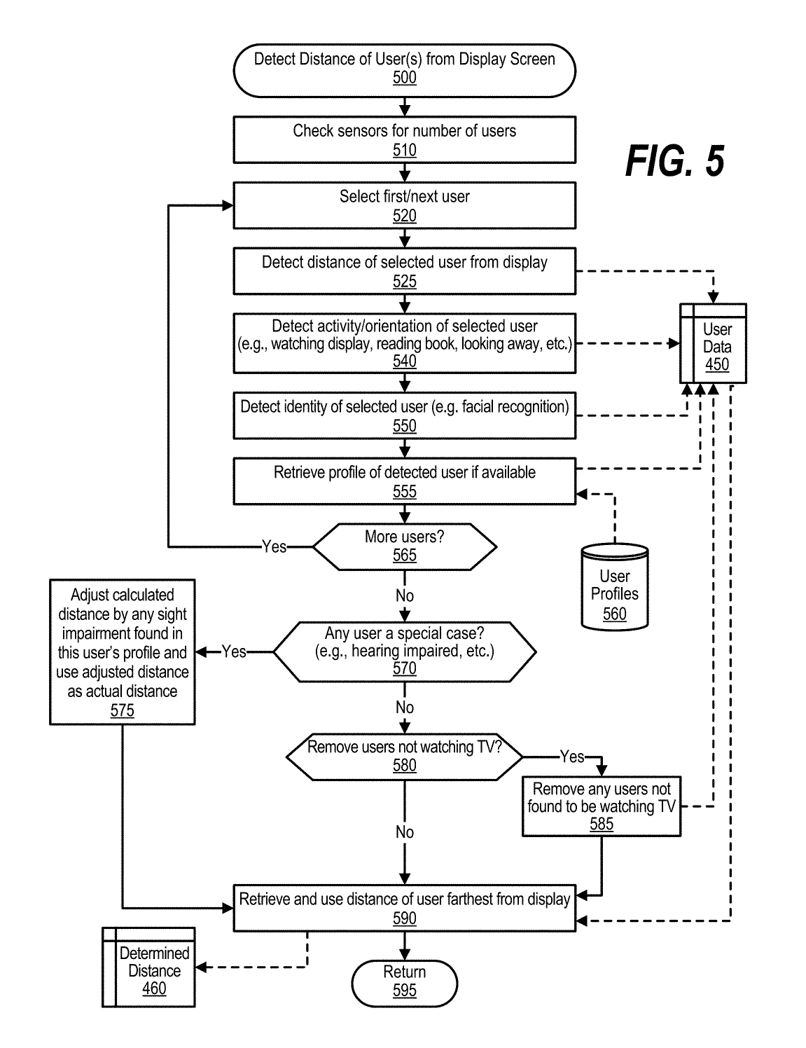

FIG. 5 is a flowchart showing steps performed to detect distance from the display device to one or more users proximate to the television display. FIG. 5 processing commences at 500 and shows the steps taken by a process that detects the distance of a user from a display device. At step 510, the process checks sensors, such as an optical distance sensor, for the number of users that are proximate to the display device. At step 520, the process selects the first user that has been detected. At step 525, the process detects the distance of the selected user from the display device. This data is stored in memory area 450 as metadata about the selected user.

At step 540, the process detects the activity and/or orientation of the selected user with respect to the display device, using a sensor such as a digital camera included in the system. For example, the selected user might be found to be watching the display device, not watching the display and instead reading book, not watching the display and, instead, looking away and having a conversation with someone. The activity of the selected user is also stored in memory area 450 as additional metadata about the selected user. At step 550, the process detects the identity of selected user, if possible, using facial recognition software to compare the selected user's face to known faces, such as found in a profile or in a social media account. The identity of the selected user is also stored in memory area 450 as metadata regarding the selected user. At step 555, if an identity of the selected user has been found, the process retrieves the profile of the detected user. The profile information retrieved from data store 560, such as the selected user's Closed Captioning preferences (e.g., table of distances and font sizes to use for this user, etc.) is also stored in memory area 450.

The process determines as to whether more users have been detected proximate to the display device (decision 565). If more users have been detected proximate to the display device, then decision 565 branches to the ‘yes’ branch which loops back to step 520 to select and process the next user as described above. This looping continues until there are no more users to process, at which point decision 565 branches to the ‘no’ branch exiting the loop.

The process determines as to whether any user is a special case with regards to Closed Captioning font size settings, such as a user that has a profile indicating that the user uses Closed Captioning and any font size information (e.g., specific table of font sizes used for the user with distance ranges and font sizes, etc.) is included in the user's profile data (decision 570). If any user is a special case user, then decision 570 branches to the ‘yes’ branch to perform step 575. On the other hand, if no users were detected as being special case users, then decision 570 branches to the ‘no’ branch bypassing step 575. At step 575, the process adjusts the calculated distance by any sight impairment found in this user's profile and use adjusted distance as actual distance. In addition, any particular Closed Captioning font size data (e.g., font size table pertaining to this user, etc.) is also noted.

The process determines whether to remove users from consideration if such users are not currently found to be watching the display device (decision 580). If a setting has been set to remove users from consideration if such users are not currently found to be watching the display device remove users not watching TV, then decision 580 branches to the ‘yes’ branch whereupon, at step 585, any users that were found to be proximate to the display device but not currently watching the display device are removed from memory area 450. On the other hand, if this is not the preference setting, then decision 580 branches to the ‘no’ branch bypassing step 585.

At step 590, the process retrieves and uses the distance of user farthest from display or, in some embodiments, a special user that was identified by the system (e.g., a user with a hearing and/or sight impairment, etc.). The determined distance is stored in memory area 460. FIG. 5 processing thereafter returns to the calling routine (see FIG. 4) at 595.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
detecting a distance from a user to a display device, wherein the detecting is performed using a sensor;
inputting the distance to a font size algorithm that determines a font size based on the detected distance; and
displaying a closed captioned text on the display device, wherein the closed captioned text is displayed in the determined font size.

2. The method of claim 1 further comprising:
detecting a plurality of users, wherein each of the users are at different locations proximate to the display device; and
identifying the user, wherein the user is a selected one of the plurality of users that is farthest from the display device.

3. The method of claim 1 further comprising:
detecting a plurality of users, wherein each of the users are at different locations proximate to the display device;
recognizing one or more identities pertaining to one or more of the plurality of users; and
retrieving a set of metadata corresponding to one or more of the identities.

4. The method of claim 3 further comprising:
retrieving a set of closed captioning font size preferences that correspond to the user at a plurality of distances;
comparing the distance of the user from the display device with the plurality of distances; and
based on the comparison, selecting one of the closed captioning font size preferences as the determined font size.

5. (canceled)

6. The method of claim 1 further comprising:
comparing the detected distance to a plurality of predetermined distance ranges, wherein each of the predetermined distance ranges corresponds to an available font size; and
selecting the determined font size based on the comparison.

7. The method of claim 6 wherein the plurality of predetermined distance ranges and corresponding font sizes are stored in a table in a nonvolatile memory, and wherein the method further comprising:
having a plurality of tables, wherein each of the tables corresponds to a different set of one or more users, wherein a selected one of the sets of users includes the user and corresponds to a selected one of the tables;
recognizing an identity pertaining to the user; and
in response to identifying the user, retrieving the selected table that corresponds to the user, wherein the comparison of the detected distance uses the predetermined distance ranges included in the selected table and selects the determined font size based on the comparison.

8. An information handling system comprising:
one or more processors;
a display screen accessible by at least one of the processors;
a sensor, accessible by at least one of the processors, that detects distances between the display screen and a user
a memory coupled to at least one of the processors; and
a set of instructions stored in the memory and executed by at least one of the processors to:
detect a distance from the user to the display screen, wherein the detecting is performed using the sensor;
input the distance to a font size algorithm that determines a font size based on the detected distance; and
display a closed captioned text on the display device, wherein the closed captioned text is displayed in the determined font size.

9. The information handling system of claim 8 wherein the instructions are further executed by the processors to:
detect a plurality of users, wherein each of the users are at different locations proximate to the display device; and
identify the user, wherein the user is a selected one of the plurality of users that is farthest from the display device.

10. The information handling system of claim 8 wherein the instructions are further executed by the processors to:
detect a plurality of users, wherein each of the users are at different locations proximate to the display device;
recognize one or more identities pertaining to one or more of the plurality of users; and
retrieve a set of metadata corresponding to one or more of the identities.

11. The information handling system of claim 10 wherein the instructions are further executed by the processors to:
retrieve a set of closed captioning font size preferences that correspond to the user at a plurality of distances;
compare the distance of the user from the display device with the plurality of distances; and
based on the comparison, select one of the closed captioning font size preferences as the determined font size.

12. (canceled)

13. The information handling system of claim 8 wherein the instructions are further executed by the processors to:
compare the detected distance to a plurality of predetermined distance ranges, wherein each of the predetermined distance ranges corresponds to an available font size; and
select the determined font size based on the comparison.

14. The information handling system of claim 13 wherein the plurality of predetermined distance ranges and corresponding font sizes are stored in a table in a nonvolatile memory, and wherein the instructions are further executed by the processors to:
have a plurality of tables, wherein each of the tables corresponds to a different set of one or more users, wherein a selected one of the sets of users includes the user and corresponds to a selected one of the tables;
recognize an identity pertaining to the user; and
in response to identifying the user, retrieve the selected table that corresponds to the user, wherein the comparison of the detected distance uses the predetermined distance ranges included in the selected table and selects the determined font size based on the comparison.

15. A computer program product comprising:
a computer readable storage medium comprising a set of computer instructions, the computer instructions effective to:
detect a distance from a user to a display screen, wherein the detecting is performed using a sensor;
input the distance to a font size algorithm that determines a font size based on the detected distance; and
display a closed captioned text on the display device, wherein the closed captioned text is displayed in the determined font size.

16. The computer program product of claim 15 wherein the instructions are further effective to:
detect a plurality of users, wherein each of the users are at different locations proximate to the display device; and
identify the user, wherein the user is a selected one of the plurality of users that is farthest from the display device.

17. The computer program product of claim 15 wherein the instructions are further effective to:
detect a plurality of users, wherein each of the users are at different locations proximate to the display device;
recognize one or more identities pertaining to one or more of the plurality of users; and
retrieve a set of metadata corresponding to one or more of the identities.

18. The computer program product of claim 17 wherein the instructions are further effective to:
retrieve a set of closed captioning font size preferences that correspond to the user at a plurality of distances;
compare the distance of the user from the display device with the plurality of distances; and
based on the comparison, select one of the closed captioning font size preferences as the determined font size.

19. (canceled)

20. The computer program product of claim 15 wherein the instructions are further effective to:
compare the detected distance to a plurality of predetermined distance ranges, wherein each of the predetermined distance ranges corresponds to an available font size; and
select the determined font size based on the comparison.
